(19) United States
(12) Patent Application Publication
(10) Pub. No.: US 2005/0261409 A1
(43) Pub. Date: Nov. 24, 2005

(54) Process for coating modified bitumen membranes using powder coatings

(75) Inventors: Amir Khan, Wayne, NJ (US); Michael De Souto, Somerset, MA (US)

Correspondence Address: Attn: William J. Davis, Esq.;GAF MATERIALS CORPORATION, Legal Department , Building No. 8, 1361 Alps Road, Wayne, NJ, 07470, US

(73) Assignee: BUILDING MATERIALS INVESTMENT CORPORATION

(21) Appl. No.: 10/851,791

(22) Filed: May 21, 2004

(51) Int. Cl. C08K 3/18; C08K 3/26

(52) U.S. Cl. 524/425; 427/180; 524/430

(57) ABSTRACT

A method of applying a powder coating composition during manufacture of modified bitumen roll roofing membranes, is provided. The coating composition is heat 5activated providing greater adherence to surfaces that it applied to, and greater reflective properties. The coating that has an initial energy efficiency rating greater than or equal to 0.65 for a low-sloped roof, or an initial energy efficiency greater than or equal to 0.25 for a steep-sloped roof.

The present invention relates to a new and useful top coating composition and a method for applying the coating, and more specifically, to a powder top coating composition for roll roofing products that is applied during the manufacturing process.

### BACKGROUND OF THE INVENTION

Modified bitumens were developed in Europe during the late 1960's for roofing applications and found a market in the United States during the 1980's. These products are an important part of the roofing industry and are produced as a continuous sheet on a roofing line and are later cut down to individual pieces and wound in rolls of various lengths. Subsequent to laying on a roof, they are top coated with coatings that provide energy efficacy and reflectivity.

With prior art white reflective coatings problems have occurred in maintaining roof surface reflectivity. Reflectivity decreases the most during the first year of a roof's life. After three years, the rate that reflectivity declines is typically less significant. Changes in reflectivity are primarily related to changes with the coating itself (e.g., coating erosion or cracking) and/or minimally related to accumulation of particulate matter (e.g., dirt) from atmospheric fallout. Depending on the geographic exposure and how well roof surfaces drain, keeping roof surfaces white and preventing premature failure from cracking and peeling can be a significant challenge and result in major maintenance expenditures for owners. Maintaining reflectivity may involve regular cleaning, regular restoration of reflective coatings, and regular application of biocides and/or fungicides. There remains a need for improved coatings with greater reflectivity, energy efficacy and durability.

Prior art coatings are applied directly to granule-surfaced modified bitumen roof membranes on new roof systems or as restorative coatings. Examples of such coatings are found in U.S. Pat. No. 6,060,555. However, granules are difficult to coat because of their rough, uneven surface areas. Moisture and air pockets can be trapped under the coating and lead to blisters or pinholes in the cured coating. Consequently, application of a compatible primer to the granule surface before coating application is required. Inconsistent coverage and potential cracking of areas where the coating is applied too heavily are additional problems related to application of previous coatings. Hence, there is a need for a method for top coating application that consistently results in uniform thicknesses of the coating.

Prior art coatings require application to the roofing membrane subsequent to placement of the modified bitumen membranes. Application requires special equipment such as a pressure washer, paddle mixer and spray rig as well as personal protective equipment. Pressure washing removes embedded dirt, chalking, carbon black and poorly adhered material. A paddle mixer is required as the coating must be completely stirred to ensure proper polymer dispersion because the solids may have settled at a container's bottom. Hence, there is a need for coating compositions that can be easily and effectively applied without the need for special equipment.

Certain coating, such as acrylic coatings develop strength and adhesion as they cure during installation. When an acrylic coating is applied, two physical changes must occur: water must evaporate from the applied coating film for initial drying and acrylic polymers must fuse together for final cure. Consequently, for application purposes multiple thin coats promote water evaporation, polymer dispersion, and help eliminate pinholes, voids or thin spots.

Application of water-based acrylic coatings is influenced by changing weather conditions. Virtually all parts of North America have some application limitations as a result of cold weather, daily rainstorms, high humidity and/or fog, or reduced daylight hours during winter. Rain on an uncured coating will cause a partial or total coating run-off. Problems occur when an acrylic coating is specified on a construction project without regard to the time of year the coating is to be installed.

Therefore, two or more successive coats of the coating are often necessary. Further, the drying of the coating is influenced by weather conditions. Cold temperatures and lack of sunlight decrease the freshly applied coating's evaporation. Water in the coating film closest to the membrane diffuses through slowly. Coatings exposed to water conditions during the drying or coating period may soften, lift and debond from the surface. This often requires cleaning of the surface and reapplication of the coating. The final cure takes place during the first few weeks after application and is essential to the coating's long term performance. Wet weather and cooler temperatures inhibit final cure and may inhibit proper fusing. Consequently, acrylic coating applications cannot be attempted on roofing projects from late fall to early spring in most North American areas.

Hence, there is a need for new and improved coating compositions that may be applied in-plant during manufacture of the roll roofing membrane. In particular, a coating composition is needed that is reflective, energy efficient (meeting today's Energy Star® criteria) as well as durable and easy to apply, and which is not vulnerable to the effects of moisture and cold temperatures during the curing process.

### SUMMARY OF THE INVENTION

The present invention provides an improved top coating composition for use in roofing products that provides energy efficacy, greater reflectivity, greater adherence, and a method of manufacture whereby the coating is applied during manufacture of the roll roofing membranes. The reflectivity provided by the inventive top coating composition, meets today's Energy Star® standards. Additionally, the roofing product produced is flexible enough to allow the product to be rolled without cracking, yet is sufficiently puncture and scuff resistant to adequately protect the top coating.

The roof coating of the invention is a white reflective powder coating that adheres well to various roof substrates, particularly modified bitumen membranes and remains adhered even under severe water-ponding conditions.

The method of the present invention involves applying the thermosetting powder coating to the roll roofing membrane while it is still hot exiting the formation line where it is produced, resulting in heat activated curing and adhesion to the membrane.

The method of the present invention results in application of a top coating of appropriate and uniform thickness.

The resulting coated roof has an initial solar reflectance and a maintained solar reflectance that meets today's Energy Stare criteria. The resulting coated roof of the present invention achieves greater reflectivity than that achievable with coatings applied subsequent to placement of the membranes on site.

The energy efficacy of the top coat is determined by its solar reflectance. Solar reflectance by definition is the fraction of solar flux reflected by a surface expressed as a percent or within the range of 0.00 and 1.00.

The top coating composition of the present invention comprises a powder dispersion of acrylic whitening agents, flame-retardants, a thickening agent, and a polymeric carrier. This coating has traditionally been used as an automobile body coating. It has surprising been discovered that this coating is useful for modified bitumen membranes. The roofing products thus produced in accordance with the present invention will possess greater reflectivity, adherence and durability.

The present invention is also related to the film, i.e. top coat, that is formed from the top coating composition of the present invention as well as roofing products that are coated with the same.

The present coating of the present invention is applied in-plant during manufacture of the roll roofing membranes in order to achieve a higher reflectivity. Application in-plant results in greater strength and adhesion to the roofing membrane. Application in-plant also results in coating of modified bitumen membranes with ease and maximum efficacy.

### BRIEF DESCRIPTION OF THE DRAWING

FIG. 1 is a flow diagram of the production of the coated modified bitumen membrane of the present invention.

### DETAILED DESCRIPTION OF THE INVENTION

As indicated above, the present invention provides a powder top coating composition or roofing products that provides energy efficacy, durable exterior protection, is highly reflective to solar energy, which is applied during the manufacture of the roll roofing membrane. The highly reflective nature of the top coating composition of the present invention provides a solar reflective coating that minimizes energy expended in air conditioning and levels temperature within a building structure.

The powder coating is applied to the roll roofing membrane and heat melted during the manufacture of the roll roofing membranes. The heat of the roof membrane activates the coating to undergo thermal curing to form a cured film and bond to the underlying membrane. The coated membrane thus produced is allowed to cure during the manufacture of the roll roofing membranes. It becomes inseparable with the modified bitumen membranes and is then wound in spiral rolls and cut to appropriate sizes. The invention reduces the time and labor involved with coating application.

The manufacture of modified bitumen membranes consists of six major operations: (1) mixing asphalt with either atactic and isotactic polypropylene or styrene-butadiene-styrene and a mineral stabilizer in large heated tanks (356° F.; 180° C.), (2) applying the mixture to a polyester or fiberglass mat-based webbing, (3) applying a polypropylene backing or mineral surfacing (top and bottom), (4) cooling and drying, (5) product finishing (seal-down strip application, cutting and trimming) and, (6) packaging. Step (4), the cooling process, occurs by passing the product around water-cooled rollers in a looper arrangement. Usually, water is also sprayed on the surfaces of the sheet to speed the cooling process.

The coating of the present invention is applied to the modified bitumen membranes as they exit the formulation line and prior to cooling, hence while they are still in a molten state. Modified bitumen membranes as they exit the formulation line are at a temperature between 125° F. and 160° F. (52° C.-72° C.). Cooling occurs in the finished product looper so that the membrane is approximately 100° F. (38° C.) at the winder. The total amount of heat to be removed is 2.1 million BTU (0.53 million Kcal per hour). The heat quantity to be removed is proportional to membrane thickness; thinner membranes can be produced at higher line speeds than thicker membranes.

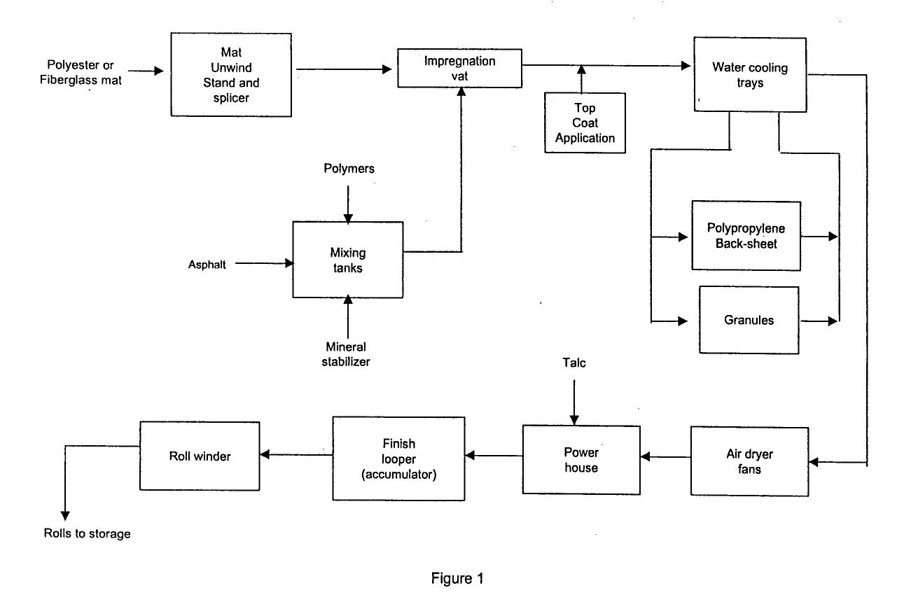

According to the present invention, in lieu of spraying with water to cool, the top coat is applied in a single yet efficient application. Via heat fusion or thermosetting the top coating permanently adheres to the membrane. The modified bitumen membrane is then allowed to cool, passed through a finish looper (accumulator) and is wound on a mandrel, cut to the proper length, and packaged. The process is depicted in FIG. 1.

The method of the present invention allows for continuous top coating application for large strip areas of modified bitumen roll roofing. The coating is flexible enough to allow the modified bitumen membrane to be rolled without cracking, sufficiently puncture and scuff resistant to adequately protect the coating.

The method of the present invention minimizes variations in coating thicknesses and results in application of the top coating in uniform thicknesses. To further insure uniform thickness, the present invention further comprises various speed controls, so that an appropriate thickness can be applied.

The method of the present invention avoids the drawbacks of coating existing bitumen membranes by applying and curing the coatings on site. The method avoids cumbersome transport and storage or the coating on site. No labor for installation and cleanup is required and installation is time efficient.

The coating composition of the present invention includes a mixture of a powder of whitening agents, flame retardants, a thickening agent, and a polymeric carrier

The mixture of the present invention has an initial reflectivity of at least 65% ASTM and a solar reflectance of at least 50% after three years exposure.

Modified bitumen roof systems are defined as polymer-modified bitumen membranes and a base sheet, reinforced with plies of fiberglass, polyester or a combination of both.

A powder coating composition is defined as a coating in the form of a powder that does not use a volatile solvent or water.

The polymer-modified bitumen membrane is modified with a polymer selected from, but not limited to, atactic (amorphous) polypropylene, polypropylene-ethylene copolymers, polyethylene, polyoxyethylene, styrene, butadiene-styrene block copolymer (SBS), styrene-ethylene-butylene-styrene block copolymer (SEBS), and styrene-isoprene-styrene block copolymer (SIS).

Reflectivity is defined as the fraction of radiant energy that is reflected from the white roofing surface. The higher the amount of reflectivity the cooler to roof has the capability of being.

Wet mil thickness is defined as the amount of coating applied to the roofing substrate equal to one thousandth of an inch while the coating is still hot.

Automobiles are treated with multiple layers of coatings which enhance the appearance of the automobile, and also provide protection from corrosion, chipping, ultraviolet light, acid rain and other environmental conditions which can deteriorate the coating appearance and underlying car body. A powder top coat is often applied to liquid basecoats. The formulations of these powder coatings typically includes but is not limited to, hydroxy functional polyester resins, cross linkers, degassing agents, flow additives, whiteners, and fillers. However, any commercially available top coat may be used herein.

The present inventors have surprisingly discovered that automotive powder top coats are suitable as topcoats for modified bitumen membranes which may be applied in a batch or continuous process.

### EXAMPLE 1

A Top Coat Formula:

| | | |
|---|---|---|
| 1. | Fine clad M8024 (polyester resin) | 44.83% |
| 2. | B 1530 (urethane cross linker) | 24.14% |
| 3. | Benzoin (degassing agent) | 0.34% |
| 4. | BYK 363 (flow additive) | 1.03% |
| 5. | KE 9594 (dibutyl tin dilaurate) | 0.69% |
| 6. | Ti-Pure | 14.48% |
| 7. | NYTAL 7700 (filler) | 14.48% |

### EXAMPLE 2

Another Formula for the Top Coat:

| | | |
|---|---|---|
| 1. | cargill 30-3011 | 38.12% |
| 2. | cargill 24-2430 | 59.99% |
| 3. | Resiflow | 1.50% |
| 4. | Benzoin | 0.39% |

The other component of the inventive top coating composition is a pigment. The pigment employed in the present invention can be any pigment that is capable of providing a highly reflective coating after the resultant mixture is cured. Typically, the pigment provides a coating that is white in color. Various shades of white are also possible as well as other colors that are capable of providing a coating that is highly reflective.

Suitable pigments that can be employed in the present invention include, but are not limited to: titanium dioxide, calcium carbonate, colemaniute, aluminum trihydride (ATH), borate compounds, and mixtures thereof. One highly preferred pigment employed in the present top coating composition is titanium dioxide, which produces a white color. The coating can be formulated in a variety of colors to conform to building aesthetics.

The pigments are employed in an amount from about 5 to about 40 wt. %, with an amount from about 10 to about 25 wt. % being more typical for one of the aforementioned pigments, preferably TiO₂.

The energy efficacy of the coating is determined by measuring its initial solar reflectance using ASTM E903 (Standard test method for solar absorptance, reflectance, and transmission of materials using integrated spheres). Alternatively, the initial solar reflectance can be determined by ASTM C 1549 (Standard test method for determination of solar reflectance near ambient temperature using a portable reflectometer).

In addition to having the aforementioned initial solar reflectance values, the coating of the present invention needs to be capable of maintaining a solar reflectance for three years after installation on a low-sloped roof under normal conditions of greater than or equal to 0.50 (measured from the first year after installation). For steep-sloped roofing products, the top coating of the present invention has to maintain a solar reflectance for three years after installation under normal conditions of greater than or equal to 0.15 (measured from the first year after installation).

Maintenance of solar reflectance of a roofing product can be determined using the current guidelines mentioned in the Energy Star® program requirements manual. The test can be carried out using ASTM E 1918 or ASTM C 1549 for low-sloped roofing products. ASTM C 1549 can be used in the case of steep-sloped roofing.

The coating composition of the present invention, which comprises a mixture of at least the above-mentioned components, may also include other optional components that are typically employed in top coating compositions. For example, the coating composition of the present invention can include any of the following components:
dispersants such as potassium tripolyphosphate, acrylic polymers or copolymers, and the like;
defoamers that are capable of preventing foaming;
fillers such as calcium carbonate, talc, white sand and the like;
solvents that are capable of serving as a coalescing agent such as ethylene glycol, propylene glycol, alcohols, and the like; preferred is ester alcohol which is a slow evaporating, water-insoluble coalescing aid.
microbiocides that serve as fungicides, e.g., zinc oxide;
thickening agents such as hydroxethyl cellulose, polyurethane, and the like;
additional fire retardants such as alumina trihydrate, zinc borate, alkali metal silicates, and the like;
pH modifiers such as aqueous ammonia;
wetting agents such as siloxanes;
light stabilizers such as hindered amines; and/or
adhesion promoters such as hydrocarbon resins.

The optional components mentioned above are present in the coating composition of the present invention in amounts that are well known to those skilled in the art.

The coating composition of the present invention is prepared by first providing a powder dispersion of at least the polymeric binder, the polymeric carrier, the pigment and the other optional ingredients while maintaining constant mixing. Mixing occurs using any mixing apparatus that can operate under low sheer conditions. By “low sheer” it is meant a mixing speed of about 60 rpm or less, which speed is capable of providing and maintaining a homogeneous mixture.

The mixing provides a powder blend of components that can be applied immediately to a surface of a building materials product or the resultant mixture can be stored for several weeks or months prior to application.

The powder blend can be applied in a batch or continuous process. In a batch process, the modified bitumen membrane is stationary during each treatment step of the process, whereas in a continuous process the modified bitumen membrane is in continuous movement along an assembly line. The present invention will now be discussed generally in the context of coating a modified bitumen membrane along an assembly line process, although the process is also useful for coating roofing membranes in a batch process.

The resultant top coating composition of the present invention can be applied to any substrate, especially roofing products or other related building materials products, by spray coating and other like coating procedures. After applying the coating composition of the present invention to a surface of a substrate, the coating composition is cured at the temperature of the environment in which the coated substrate is located. Curing can take place in just a few minutes or longer depending on the thickness of the applied coating as well as the environmental temperature.

The coating composition of the present invention is generally applied to the exterior surface of a substrate. In particular, the coating composition is generally applied to an expose exterior surface of a roofing product including low-sloped roofing products such as single ply membranes, built-up roofing (BUR), modified bitumen, ethylene propylene diene monomer (EPDM) rubber and standing-seam profile metal roofing, or steep sloped roofing products such as composite shingles, clay, concentrate, fiber cement tile, slate, shakes, architectural profiled metal and individual roofing components. In some preferred applications, the coating composition of the present invention is applied to BUR surfaces, modified bitumen and EPDM rubber.

After application and curing, a top coat is provided to the substrate that provides durable protection to the substrate from abrasion, impact, water, and other environmental factors. Moreover, the top coat provided by the present invention is capable of extending the lifetime of the current roofing system. The top coat provided in the present invention is also breathable meaning that it has excellent porosity, which allows for venting of vapors.

In addition to the foregoing properties, the top coat that is formed using the inventive composition has a high reflectivity that meets and even may exceed current Energy Star® values.

The optional components mentioned above are present in the coating composition of the present invention in amounts that are well known to those skilled in the art.

While the coating of the present invention is directed to modified bitumen roof membranes, such as APP and SBS polymer modified bitumens, it is understood that it may be applied to other roof systems such as, but not limited to, granule- and mineral-surfaced modified bitumen cap sheets, metal roof systems, masonry surfaces, build-up roof (BUR) systems (BUR systems consist of bitumen and ply sheets applied in multiple layers, hence the term “built-up”), EPDM, PVC, Hypalon® and substrates such as spray polyurethane foam (SPF).

The coating can be applied in a powder state at a specified application rate which results in a coating thickness of between about 0.1 to 0.9 mm (4 to 36 mils). For all application purposes, the coating can be applied in two or more thin coats or one thick coat.

The coating may be applied by spray, brush or roller. According to the present invention, spraying is preferred. The use of spray equipment comprises: a source means for providing a supply of the powder coating; a pump means for pumping such coating; and a spray means for spraying such coating. A spray pump capable of developing 1,800-psi material output pressure should be sufficient to spray the coating of the present invention. Alternatively, hydraulic or pneumatic pumps may be used. The source means may be a drum or other such material feeding apparatus.

The coating of the present invention may be used with or without surface priming.

The coating of the present invention is applied to the modified bitumen roll roofing membrane during manufacture. Alternatively, the coating may be applied to the roof and cured in situ or “manufactured in place.

While the invention has been described for use in roofing materials, it is also usable for coating applications on siding or at ground level such as for pavement painting or sealing applications.

### EXAMPLE 3

The process for manufacture of the top coat of the present invention is as follows:

The asphalt is heated to 400° F. Polymer is added and high shear mixed. Additional fillers are added under low shear. The asphalt compound made undergoes Quality Control inspection. Upon QC approval it is then pumped to the production line. The compound is saturated in reinforcement. The white powder is applied to the surface of the asphalt membrane. While the membrane is hot, when powder is added it is heat activated and fuses to the membrane. The temperature ranges from 200° F.-400° F. The combo is cooled, dried and rolled up in 100 sq. ft.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated but fall within the scope of the appended claims.

1. A method of coating a modified bitumen roll roofing membrane in-plant comprising the steps of:
(a) applying a layer of a white reflective powder coating upon a surface of a modified bitumen roll roofing membrane exiting from a formation line;
(b) permitting said white reflective coating to heat activate; and
(c) allowing the dispersion to cure and adhere to said surface.

2. The method of claim 1 further comprising applying a second layer of white reflective powder coating therein over said modified bitumen roll roofing membrane.

3. The method of claim 1 wherein said white reflective powder coating is applied by a spray.

4. A method for improving adhesion between a white reflective powder coating and a modified bitumen membrane, which method comprises:
(a) treating a surface of a modified bitumen roll roofing membrane with a white reflective powder coating while said membrane is still hot exiting the formation line during manufacture;
(b) permitting said coating to heat activate; and
(c) allowing the coating to cure and adhere to the surface.

5. A method for improving reflectivity of a roof coating, which method comprises:
(a) treating a surface of a modified bitumen roll roofing membrane with a white reflective powder coating while said membrane is still hot exiting the formation line during manufacture;
(b) permitting said coating to heat activate; and
(c) allowing the coating to cure and adhere to the surface.

6. A powder top coating composition of high energy efficacy, reflectance, and durability comprising:
a thermosetting powder coating that has an initial energy efficacy rating greater than or equal to 0.65 for a low-sloped roof, or an initial energy efficacy greater than or equal to 0.25 for a steep-sloped roof; wherein said coating adheres to roll roofing membranes by heat activation during manufacturing.

7. The powder top coating composition of claim 6 wherein said roll roofing membrane is a polymer-modified bitumen membrane.

8. The powder top coating composition of claim 7 wherein said polymer-modified bitumen membrane is modified with a polymer selected from the group consisting of atactic (amourphous) polypropylene, polypropylene-ethylene copolymers, polyethylene, polyoxyethylene, styrene, butadiene-styrene block copolymer (SBS), styrene-ethylene-butylene-styrene block copolymer (SEBS), and styrene-isoprene-styrene block copolymer (SIS).

9. The powder top coating composition of claim 6, wherein the coating is an automotive body top coat.
